(19) United States
(12) Patent Application Publication
(10) Pub. No.: US 2014/0279483 A1
(43) Pub. Date: Sep. 18, 2014

(54) MOBILE PAYMENT VIA TRANSFER NETWORK

(71) Applicant: BANK OF AMERICA CORPORATION, Charlotte, NC (US)

(72) Inventors: Eileen D. Bridges, Fort Mill, SC (US); Lisa Gibson, Newnan, GA (US); James G. Ronca, Decatur, GA (US); Mark D. Zanzot, Huntersville, NC (US); Susan Smith Thomas, Gastonia, NC (US)

(73) Assignee: Bank of America Corporation, Charlotte, NC (US)

(21) Appl. No.: 13/804,095

(22) Filed: Mar. 14, 2013

(51) Int. Cl. G06Q 20/16

(52) U.S. Cl. CPC G06Q 20/16
USPC 705/42

(57) ABSTRACT

Embodiments of the invention are directed to systems, methods and computer program products for making a payment via a transfer network. In some embodiments, a first apparatus is configured to: receive readable indicia and payment information from a second apparatus, wherein the payment information comprises an amount of funds; identify an account associated with the readable indicia based on searching a database of records; process the payment information, wherein processing the payment information comprises transmitting to the identified account the determined amount of funds; transmit an acknowledgement of payment transfer to a third apparatus associated with the identified account.

### BACKGROUND

There is a need to enable a user to quickly and efficiently make a mobile payment via a transfer network.

### BRIEF SUMMARY

In some embodiments, an apparatus for making a mobile payment via a transfer network is provided. The apparatus comprises a memory; a processor; and a module stored in memory, executable by the processor, and configured to: receive readable indicia and payment information from a second apparatus, wherein the payment information comprises an amount of funds; identify an account associated with the readable indicia based on searching a database of records; process the payment information, wherein processing the payment information comprises transmitting to the identified account the determined amount of funds; transmit an acknowledgement of payment transfer to a third apparatus associated with the identified account.

In some embodiments, receiving the readable indicia and the payment information further comprises capturing the readable indicia and payment information.

In some embodiments, the apparatus comprises an image capturing component, wherein the image-capturing component comprises at least one of a camera, a scanner, a mobile device, or a point of sale device.

In some embodiments, receiving the readable indicia and the payment information comprises identifying information associated with a transaction, wherein the information comprises at least one of a business name, a business type, a location associated with the transaction, a date, an amount of funds, a memo description, a check number, a card number, an account number, or a routing number.

In some embodiments, the readable indicia and the payment information are associated with at least one of a quick response (QR) code, near field communication (NFC), a bar code, a serial number, an account number, a user identification number, a phone number, a text string, a tax identification number, or an employer identification number (EIN).

In some embodiments, identifying the account associated with the readable indicia requires additional security authentication.

In some embodiments, the readable indicia is configured to be associated with multiple accounts.

In some embodiments, the amount of funds is associated with at least one of a numerical value of cash, a check, a credit, a gift card, or an alias.

In some embodiments, the amount of funds is modifiable by a user and comprises at least one of a subtotal, a tax, a tip, or a total amount.

In some embodiments, processing the payment information comprises presenting to a user an interface that enables the user to select at least one of a payee, a payment source, a payment amount, or an account from which the amount of funds will be transmitted.

In some embodiments, the interface enables the user to split the amount of funds into multiple smaller amounts.

In some embodiments, splitting the amount of funds enables the user to select multiple sources of payment or accounts from which the amount of funds will be transmitted.

In some embodiments, the module generates a dynamic list of payees based on the second apparatus' proximity to the apparatus, wherein the proximity is determined using location information associated with the second apparatus.

In some embodiments, the apparatus further comprises: determining an account from which the amount of funds will be transmitted, and in response to determining the account from which the amount of funds will be transmitted, processing the payment information to determine whether the account from which the amount of funds will be transmitted comprises sufficient funds to complete the transaction.

In some embodiments, transmitting an acknowledgement of payment transfer comprises generating a receipt or a receipt image of transaction information.

In some embodiments, the acknowledgement comprises at least one of a text message, an email, a notification, a status update, a digital receipt, or a printed receipt.

In some embodiments, the readable indicia is static or dynamic.

In some embodiments, the module processes the payment information via a transfer network.

In some embodiments, a method for making a mobile payment via a transfer network is provided. The method comprises: receiving readable indicia and payment information from a second apparatus, wherein the payment information comprises an amount of funds; identifying an account associated with the readable indicia based on searching a database of records; processing the payment information, wherein processing the payment information comprises transmitting to the identified account the determined amount of funds; transmitting an acknowledgement of payment transfer to a third apparatus associated with the identified account.

In some embodiments, a computer program product for making a mobile payment via a transfer network is provided. The computer program product comprises a non-transitory computer-readable medium comprising code causing a computer to: receive readable indicia and payment information from a second apparatus, wherein the payment information comprises an amount of funds; identify an account associated with the readable indicia based on searching a database of records; process the payment information, wherein processing the payment information comprises transmitting to the identified account the determined amount of funds; transmit an acknowledgement of payment transfer to a third apparatus associated with the identified account.

### BRIEF DESCRIPTION OF THE DRAWINGS

Having thus described embodiments of the invention in general terms, reference will now be made to the accompanying drawings, where:

FIG. 1 is a general process flow for making a mobile payment via a transfer network, in accordance with embodiments of the present invention;

FIG. 2 is an exemplary user interface for making a mobile payment via a transfer network, in accordance with embodiments of the present invention;

FIG. 3 is a block diagram illustrating technical components of a system for enrolling a user in a program for making a payment via a transfer network, in accordance with embodiments of the present invention.

### DETAILED DESCRIPTION OF EMBODIMENTS OF THE INVENTION

Embodiments of the present invention now may be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure may satisfy applicable legal requirements. Like numbers refer to like elements throughout.

Embodiments of the invention are directed to systems, methods and computer program products for making a mobile payment via a transfer network, in accordance with embodiments of the present invention.

In some embodiments, an “entity” as used herein may be a financial institution. For the purposes of this invention, a “financial institution” may be defined as any organization, entity, or the like in the business of moving, investing, or lending money, dealing in financial instruments, or providing financial services. This may include commercial banks, thrifts, federal and state savings banks, savings and loan associations, credit unions, investment companies, insurance companies and the like. In some embodiments, the entity may allow a user to establish an account with the entity. An “account” may be the relationship that the user has with the entity. Examples of accounts include a deposit account, such as a transactional account (e.g. a banking account), a savings account, an investment account, a money market account, a time deposit, a demand deposit, a pre-paid account, a credit account, a non-monetary user profile that includes only personal information associated with the user, or the like. The account is associated with and/or maintained by an entity. In other embodiments, an “entity” may not be a financial institution.

In some embodiments, the “user” may be a customer (e.g. an account holder or a person who has an account (e.g. banking account, credit account, or the like) at the entity). In alternate embodiments, the “user” may be a merchant (e.g. a business, a vendor, a service provider, or the like). The user may also be an agent (customer service representative, internal operations specialist, bank teller, account manager, or the like) associated with the entity.

As used herein, “readable indicia” may refer to a variety of information types. In some embodiments, readable indicia may refer to a quick response (QR) code, a bar code, biometric information, a user identification code, a serial number, a phone number, a text string, an employee identification number (EIN), a tax identification number, or the like. In some embodiments, the readable indicia may include near field communication (NFC) technology. As used herein, the “QR code” may refer to any other type of readable indicia (either visible or invisible readable indicia).

As used herein, the “mobile device” may be a wide variety of computing devices. In some embodiments, the mobile device may refer to a smart phone, a laptop, a tablet, or the like. In other embodiments, the mobile device may refer to a desktop or rack-mounted computing device.

The present invention may enable an apparatus (e.g. a computer system) associated with the entity to facilitate a mobile payment via a transfer network. This invention may be particularly useful if the user wishes to make a payment without cash or check. For example, if the user is riding in a taxi cab, and the user does not have cash to pay the cab driver his fare, then the user may opt to make a payment using his mobile device, wherein a myriad of transaction types are available, including but not limited to a withdrawal, a deposit, a purchase, a funds transfer, a return, a coupon redemption, or the like. A transaction may be completed from a mobile device wherein the device includes an application associated with the entity, such as a mobile banking application.

First, the merchant may register with the mobile banking application. In some embodiments, the merchant may be prompted to manually enter the business name, the business type, the location, the bank account number associated with the business, or the like. In other embodiments, the apparatus may collect this information automatically.

Once the merchant is registered with the mobile banking application, the apparatus may assign the merchant to a readable indicia, such as a QR code. In some embodiments, the QR code may be unique to the merchant. In other embodiments, the QR code may be dynamically assigned to multiple merchants. For example, if there is one QR code in a taxi cab, but multiple drivers operate the taxi cab throughout the day, the apparatus may be configured to change an account associated with the QR code. This ensures that a payment is transmitted to the correct cab driver. The merchant may be required to create an account, a username, a password, a passcode, a personal identification number (PIN), or the like prior to accessing the application.

Typically, the apparatus associates the merchant's bank account with the QR code. In some embodiments, multiple accounts may be associated with the QR code. For example, the merchant may have a debit card, a payment network, a checking account, and a gift card associated with the QR code. In some embodiments, the merchant may select from a list the account into which a payment amount is transferred. In other embodiments, the apparatus may automatically determine into which account the payment amount is transferred.

In some embodiments, the QR code may be statically assigned. For example, the QR code may be assigned to one merchant. In some embodiments, the QR code may be associated with an alias (e.g., an email address, a telephone number, a social networking identity, or the like). In other embodiments, the QR code may be dynamically assigned. For example, the QR code may be assigned to multiple merchants. Additional security authentication may be required to change the assignment of the QR code.

Once the merchant's account is associated with the QR code, a user may make a payment to the merchant for a product or a service via the user's mobile device. The apparatus may present to the user's mobile device an interface with which to complete the transaction.

First, the user may capture or receive the QR code. The QR code may be captured in a variety of ways. Typically, the QR code is available for capture at the point of sale. In some embodiments, the user may capture the QR code using a camera on his mobile device. In some embodiments, the user may use a scanner to capture the QR code. In some embodiments, the user may manually enter a serial number, identification number, employer identification number (EIN), or the like, or select the merchant associated with the QR code from a list of nearby or applicable merchants. The apparatus may determine the merchant to be nearby or applicable based on location information (geo-location information, global positioning system (GPS) coordinates, longitude and latitude, information associated with a transaction, or the like). In other embodiments, the user may receive the QR code via a point of sale device, an electronic transmission, or the like. The apparatus may be further configured transmit funds between multiple users or multiple payees.

Typically, readable indicia is associated with payment information, which is information used to identify a transaction, a payee, or a user. Payment information may include but is not limited to a business name, a business type, a location associated with the transaction, a date, an amount of funds, a memo description, a check number, a card number, an account number, or a routing number.

After the QR code is captured, the apparatus may transmit to the user a payment amount associated with the transaction. In other embodiments, the user may input the payment amount. Typically, the payment amount is associated with a numerical value of cash, a check, a credit, a gift card, an alias (an email address, a telephone number, a social network identity associated with an account, or the like), or the like. The payment amount may include a subtotal, a tax, a tip, a total amount, or the like. The payment amount may resemble a bill. In some embodiments, the merchant establishes the payment amount. In other embodiments, the user may establish or modify the payment amount. For example, if a ride in a taxi cab totals $40, the user may wish to add a tip amount on top of the $40. The apparatus may automatically calculate or include the tip amount. Further, the user may be able to split the payment amount into multiple payment amounts. For example, if multiple people ride in a taxi cab, the user may split the bill of the cab ride between the multiple riders.

In some embodiments, the user may select the payment source he wishes to use to complete the transaction. The payment source may include but is not limited to cash, a credit card, a debit card, a gift card, a store credit, a virtual currency, an alias, a transfer network, a checking account, a savings account, or the like. The apparatus may store information associated with the payment source in a database for quick recall. In other embodiments, the database may be stored in a cloud server accessible to the apparatus. Depending on the payment source selected, the user may be prompted to enter additional security authorization. Security authorization may include entering a PIN, answering a security question, or the like.

In some embodiments, the user may select one payment source. In other embodiments, the user may select multiple payment sources. For example, the user may choose to pay half of the bill with a credit card and the other half of the bill with a gift card.

Upon selecting the payment amount and the payment source, the user may submit the payment to the apparatus. After the payment is submitted, the apparatus may confirm that the user's payment source comprises sufficient funds to cover the payment amount in full. In some embodiments, the apparatus may conduct a test transaction to confirm that the user's payment source comprises sufficient funds.

Positive confirmation of sufficient funds enables the apparatus to withdraw the payment amount from the payment source and transfer the payment amount to the account associated with the QR code. In some embodiments, the apparatus may utilize a transfer network to withdraw and transfer the payment amount. The advantage of utilizing a transfer network is that information associated with the user's payment source and the account associated with the QR code is transferred over a secure network. Essentially, the transfer network may serve as a secure third-party hub from which the transaction is completed.

Upon the successful transmission of the payment amount, the apparatus may generate a payment receipt. In some embodiments, the payment receipt may be printed on paper. In other embodiments, the payment receipt may be electronic. For example, an electronic payment receipt may include an image or text containing information regarding the transaction. Information contained in the receipt may include but is not limited to a payee name, a payee type, a payment amount, a payment date, a payment source, a memo description, an account number, a routing number, or the like.

The payment receipt may be transmitted to the merchant or to the user. The receipt may be generated by a mobile device, a portable printer, a point of sale device, or the like. In some embodiments, the payment receipt may be printed out at the point of sale. In other embodiments, the payment receipt may be transmitted electronically via an email, a text message, a short messaging system (SMS), a social network post, or the like.

FIG. 1 illustrates a process flow 100 that explains the method of making a mobile payment via a transfer network. At block 110, the method comprises receiving, at a first apparatus, readable indicia and payment information from a second apparatus, wherein the payment information comprises an amount of funds. At block 120, the method comprises identifying an account associated with the readable indicia based on searching a database of records. At block 130, the method comprises processing the payment information, wherein processing the payment information comprises transmitting to the identified account the determined amount of funds. At block 140, the method comprises transmitting an acknowledgement of payment transfer to a third apparatus associated with the identified account.

FIG. 2 illustrates an exemplary interface presented to the user's mobile device. The presented interface enables the user to execute a variety of transactions related to making a payment via a transfer network.

When the user selects the “Capture” 210 tab, the apparatus may present to the user's mobile device a menu of options to capture the readable indicia. In some embodiments, the user's mobile device may include a capturing device, such as a camera, a scanner, or the like. For example the Capture 210 tab may utilize the mobile device's camera to capture the readable indicia. In other embodiments, the apparatus may be associated with an Automated Teller Machine (ATM) or similar device at a facility associated with the entity.

When the user selects the “Select Payee” 220 tab, the apparatus may present to the user a menu of payee names, payee types, or the like. The payees are associated with the readable indicia. In some embodiments, the apparatus may automatically assign the payee with the readable indicia. In other embodiments, the apparatus may require the user to input or select the payee. The apparatus may produce a list of payees based on location information (global positioning system (GPS) coordinates, longitude and latitude, proximity to a network, or the like). The user may select at least one payee from the list. In some embodiments, the user may select multiple payees from the list of multiple payees. In other embodiments, the user may not be prompted to select the payee from the list of payees and the apparatus may automatically determine and assign the correct payee to the Select Payee 220 field.

When the user selects the “Select Payment Source” 230 tab, the apparatus may present to the user a menu of available payment sources. Typically, the payment source includes cash, a credit card, a debit card, an electronic currency, a credit, a gift card, a transfer network, an alias (e.g. telephone number, email address, a social networking identity, or the like), or the like. In some embodiments, the apparatus may store the user's information associated with a debit card, a credit card, a bank account, an alias, a gift card, or the like for quick recall.

When the user selects the “Enter Payment Amount” 240 tab, the apparatus may present to the user an entry field into which the user may enter the payment amount. The payment amount is the amount of the transaction that the user must pay to complete the transaction. Typically, the payment amount includes at least one of a subtotal, a tax, a tip, or a total amount. In some embodiments, the payment amount may be determined by the merchant, wherein the payment amount is transmitted to the user's mobile device. In some embodiments, the payment amount may not be modifiable. In other embodiments, the payment amount may be determined or modified by the user. For example, the user may receive a subtotal from the merchant. The user may determine a tip amount he wishes to add on top of the subtotal amount and the tax amount. The apparatus may automatically update a total payment amount based on the subtotal, tax, and tip amounts.

When the user selects the “Complete Transaction” 250 tab, the apparatus may submit the payment information. Once the payment information is submitted, the apparatus may confirm that the user's payment source comprises sufficient funds needed to complete the transaction. Upon positive confirmation, the apparatus may retrieve the payment amount from the user's payment source and transfer the payment amount to the account associated with the QR code.

FIG. 3 presents an exemplary block diagram of the system environment 300 for implementing the process flow described in FIG. 1 in accordance with embodiments of the present invention. As illustrated, the system environment 300 includes a network 310, a readable indicia 320, a system 330, and a user input system 340. Also shown in FIG. 3 is a user 345 of the user input system 340. The user input system 340 may be a mobile device described herein. The user 345 may be a person who uses the user input system 340 to execute a user application 347. The user application 347 may be an application to communicate with the readable indicia 320, system 330, perform a transaction, input information onto a user interface presented on the user input system 340, or the like. The user application 347 and/or the system application 337 may incorporate one or more parts of any process flow described herein.

As shown in FIG. 3, the system 330, and the user input system 340 are each operatively and selectively connected to the network 310, which may include one or more separate networks. In addition, the network 310 may include a telecommunication network, local area network (LAN), a wide area network (WAN), and/or a global area network (GAN), such as the Internet. It will also be understood that the network 310 may be secure and/or unsecure and may also include wireless and/or wireline and/or optical interconnection technology.

The readable indicia 320 refers to a code associated with the payee used to identify the payee. The type of readable indicia may include but is not limited to a QR code, a bar code, a serial number, a tax identification number, an EIN, or the like. The readable indicia is captured via an image-capturing device, such as a camera, a scanner, a point of sale device, or the like. The readable indicia 320 may comprise a static sticker or may be presented on an electronic display.

The user input system 340 may include any computerized apparatus that can be configured to perform any one or more of the functions of the user input system 340 described and/or contemplated herein. For example, the user 345 may use the user input system 340 to transmit and/or receive information or commands to and from the system 330. In some embodiments, for example, the user input system 340 may include a personal computer system (e.g. a non-mobile or non-portable computing system, a motor vehicle, or the like), a mobile computing device, a personal digital assistant, a mobile phone, a tablet computing device, a network device, and/or the like. As illustrated in FIG. 3, in accordance with some embodiments of the present invention, the user input system 340 includes a communication interface 342, a processor 344, a memory 346 having an user application 347 stored therein, and a user interface 349. In such embodiments, the communication interface 342 is operatively and selectively connected to the processor 344, which is operatively and selectively connected to the user interface 349 and the memory 346. In some embodiments, the user 345 may use the user application 347 to execute processes described with respect to the process flows described herein. Specifically, the user application 347 executes the process flow described in FIG. 1.

Each communication interface described herein, including the communication interface 342, generally includes hardware, and, in some instances, software, that enables the user input system 340, to transport, send, receive, and/or otherwise communicate information to and/or from the communication interface of one or more other systems on the network 310. For example, the communication interface 342 of the user input system 340 may include a wireless transceiver, modem, server, electrical connection, and/or other electronic device that operatively connects the user input system 340 to another system such as the system 330. The wireless transceiver may include a radio circuit to enable wireless transmission and reception of information. Additionally, the user input system 340 may include a positioning system. The positioning system (e.g. a global positioning system (GPS), a network address (IP address) positioning system, a positioning system based on the nearest cell tower location, or the like) may enable at least one of the user input system 340 or an external server or computing device in communication with the user input system 340 to determine the location (e.g. location coordinates) of the user input system 340.

Each processor described herein, including the processor 344, generally includes circuitry for implementing the audio, visual, and/or logic functions of the user input system 340. For example, the processor may include a digital signal processor device, a microprocessor device, and various analog-to-digital converters, digital-to-analog converters, and other support circuits. Control and signal processing functions of the system in which the processor resides may be allocated between these devices according to their respective capabilities. The processor may also include functionality to operate one or more software programs based at least partially on computer-executable program code portions thereof, which may be stored, for example, in a memory device, such as in the user application 347 of the memory 346 of the user input system 340.

Each memory device described herein, including the memory 346 for storing the user application 347 and other information, may include any computer-readable medium. For example, memory may include volatile memory, such as volatile random access memory (RAM) having a cache area for the temporary storage of information. Memory may also include non-volatile memory, which may be embedded and/or may be removable. The non-volatile memory may additionally or alternatively include an EEPROM, flash memory, and/or the like. The memory may store any one or more of pieces of information and data used by the system in which it resides to implement the functions of that system.

As shown in FIG. 3, the memory 346 includes the user application 347. The user application 347 may be associated with various features described herein. In some embodiments, the user application 347 includes an interface for communicating with, navigating, controlling, configuring, and/or using the user input system 340. In some embodiments, the user application 347 includes computer-executable program code portions for instructing the processor 344 to perform one or more of the functions of the user application 347 described and/or contemplated herein. In some embodiments, the user application 347 may include and/or use one or more network and/or system communication protocols.

Also shown in FIG. 3 is the user interface 349. In some embodiments, the user interface 349 includes one or more output devices, such as a display and/or speaker, for presenting information to the user 345. In some embodiments, the user interface 349 includes one or more input devices, such as one or more buttons, keys, dials, levers, directional pads, joysticks, accelerometers, controllers, microphones, touchpads, touchscreens, haptic interfaces, microphones, scanners, motion detectors, cameras, and/or the like for receiving information from the user 345. In some embodiments, the user interface 349 includes the input and display devices of a mobile device, which are operable to receive and display information.

FIG. 3 also illustrates a system 330, in accordance with an embodiment of the present invention. The system 330 may refer to the “apparatus” described herein. The system 330 may include any computerized apparatus that can be configured to perform any one or more of the functions of the system 330 described and/or contemplated herein. In accordance with some embodiments, for example, the system 330 may include a computer network, an engine, a platform, a server, a database system, a front end system, a back end system, a personal computer system, and/or the like. Therefore, the system 330 may be a server managed by the entity. The system 330 may be located at the facility associated with the entity or remotely from the facility associated with the entity. In some embodiments, such as the one illustrated in FIG. 3, the system 330 includes a communication interface 332, a processor 334, and a memory 336, which includes a system application 337 and a datastore 338 stored therein. As shown, the communication interface 332 is operatively and selectively connected to the processor 334, which is operatively and selectively connected to the memory 336.

It will be understood that the system application 337 may be configured to implement any one or more portions of the various user interfaces and/or process flow described herein. The system application 337 may interact with the user application 347. It will also be understood that, in some embodiments, the memory includes other applications. It will also be understood that, in some embodiments, the system application 337 is configured to communicate with the datastore 338, the user input system 340, or the like.

It will be further understood that, in some embodiments, the system application 337 includes computer-executable program code portions for instructing the processor 334 to perform any one or more of the functions of the system application 337 described and/or contemplated herein. In some embodiments, the system application 337 may include and/or use one or more network and/or system communication protocols.

In addition to the system application 337, the memory 336 also includes the datastore 338. As used herein, the datastore 338 may be one or more distinct and/or remote datastores. In some embodiments, the datastore 338 is not located within the system and is instead located remotely from the system. In some embodiments, the datastore 338 stores information or data described herein. For example, the datastore 338 may store information associated with the user's account.

It will be understood that the datastore 338 may include any one or more storage devices, including, but not limited to, datastores, databases, and/or any of the other storage devices typically associated with a computer system. It will also be understood that the datastore 338 may store information in any known way, such as, for example, by using one or more computer codes and/or languages, alphanumeric character strings, data sets, figures, tables, charts, links, documents, and/or the like. Further, in some embodiments, the datastore 338 may include information associated with one or more applications, such as, for example, the system application 337. It will also be understood that, in some embodiments, the datastore 338 provides a substantially real-time representation of the information stored therein, so that, for example, when the processor 334 accesses the datastore 338, the information stored therein is current or substantially current.

It will be understood that the embodiment of the system environment illustrated in FIG. 3 is exemplary and that other embodiments may vary. As another example, in some embodiments, the system 330 includes more, less, or different components. As another example, in some embodiments, some or all of the portions of the system environment 300 may be combined into a single portion. Likewise, in some embodiments, some or all of the portions of the system 330 may be separated into two or more distinct portions.

In addition, the various portions of the system environment 300 may be maintained for and/or by the same or separate parties. It will also be understood that the system 330 may include and/or implement any embodiment of the present invention described and/or contemplated herein. For example, in some embodiments, the system 330 is configured to implement any one or more of the embodiments of the process flows described and/or contemplated herein in connection any process flow described herein. Additionally, the system 330 or the user input system 340 is configured to initiate presentation of any of the user interfaces described herein.

In accordance with embodiments of the invention, the term “module” with respect to a system may refer to a hardware component of the system, a software component of the system, or a component of the system that includes both hardware and software. As used herein, a module may include one or more modules, where each module may reside in separate pieces of hardware or software.

Although many embodiments of the present invention have just been described above, the present invention may be embodied in many different forms and should not be construed as limited to the embodiments set forth herein; rather, these embodiments are provided so that this disclosure will satisfy applicable legal requirements. Also, it will be understood that, where possible, any of the advantages, features, functions, devices, and/or operational aspects of any of the embodiments of the present invention described and/or contemplated herein may be included in any of the other embodiments of the present invention described and/or contemplated herein, and/or vice versa. In addition, where possible, any terms expressed in the singular form herein are meant to also include the plural form and/or vice versa, unless explicitly stated otherwise. Accordingly, the terms “a” and/or “an” shall mean “one or more,” even though the phrase “one or more” is also used herein. Like numbers refer to like elements throughout.

As will be appreciated by one of ordinary skill in the art in view of this disclosure, the present invention may include and/or be embodied as an apparatus (including, for example, a system, machine, device, computer program product, and/or the like), as a method (including, for example, a business method, computer-implemented process, and/or the like), or as any combination of the foregoing. Accordingly, embodiments of the present invention may take the form of an entirely business method embodiment, an entirely software embodiment (including firmware, resident software, micro-code, stored procedures in a database, or the like), an entirely hardware embodiment, or an embodiment combining business method, software, and hardware aspects that may generally be referred to herein as a “system.” Furthermore, embodiments of the present invention may take the form of a computer program product that includes a computer-readable storage medium having one or more computer-executable program code portions stored therein. As used herein, a processor, which may include one or more processors, may be “configured to” perform a certain function in a variety of ways, including, for example, by having one or more general-purpose circuits perform the function by executing one or more computer-executable program code portions embodied in a computer-readable medium, and/or by having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, electromagnetic, infrared, and/or semiconductor system, device, and/or other apparatus. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as, for example, a propagation signal including computer-executable program code portions embodied therein.

One or more computer-executable program code portions for carrying out operations of the present invention may include object-oriented, scripted, and/or unscripted programming languages, such as, for example, Java, Perl, Smalltalk, C++, SAS, SQL, Python, Objective C, JavaScript, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

Some embodiments of the present invention are described herein with reference to flowchart illustrations and/or block diagrams of apparatus and/or methods. It will be understood that each block included in the flowchart illustrations and/or block diagrams, and/or combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

The one or more computer-executable program code portions may be stored in a transitory and/or non-transitory computer-readable medium (e.g. a memory) that can direct, instruct, and/or cause a computer and/or other programmable data processing apparatus to function in a particular manner, such that the computer-executable program code portions stored in the computer-readable medium produce an article of manufacture including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with, and/or replaced with, operator- and/or human-implemented steps in order to carry out an embodiment of the present invention.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the just described embodiments can be configured without departing from the scope and spirit of the invention. Therefore, it is to be understood that, within the scope of the appended claims, the invention may be practiced other than as specifically described herein.

1. An apparatus for making a mobile payment via a transfer network, the apparatus comprising:
a memory;
a processor; and
a module stored in memory, executable by the processor, and configured to:
receive readable indicia and payment information from a second apparatus, wherein the readable indicia is configured to be associated with more than one merchant, wherein the payment information comprises an amount of funds, and wherein the amount of funds comprises at least one of a subtotal, a tax, a tip, and a total amount, and is modifiable by an end user;
identify an account associated with the readable indicia based on searching a database of records;
process the payment information, wherein processing the payment information comprises transmitting to the identified account the determined amount of funds;
transmit an acknowledgement of payment transfer to a third apparatus associated with the identified account.

2. The apparatus of claim 1, wherein receiving the readable indicia and the payment information further comprises capturing the readable indicia and payment information.

3. The apparatus of claim 1, wherein the apparatus comprises an image capturing component, wherein the image-capturing component comprises at least one of a camera, a scanner, a mobile device, or a point of sale device.

4. The apparatus of claim 1, wherein receiving the readable indicia and the payment information comprises identifying information associated with a transaction, wherein the information comprises at least one of a business name, a business type, a location associated with the transaction, a date, an amount of funds, a memo description, a check number, a card number, an account number, or a routing number.

5. The apparatus of claim 1, wherein the readable indicia and the payment information are associated with at least one of a quick response (QR) code, near field communication (NFC), biometric information, a bar code, a serial number, an account number, a user identification number, a phone number, a text string, a tax identification number, or an employer identification number (EIN).

6. The apparatus of claim 1, wherein identifying the account associated with the readable indicia requires additional security authentication.

7. (canceled)

8. The apparatus of claim 1, wherein the amount of funds is associated with at least one of a numerical value of cash, a check, a credit, a gift card, or an alias.

9. (canceled)

10. The apparatus of claim 1, wherein processing the payment information comprises presenting to a user an interface that enables the user to select at least one of a payee, a payment source, a payment amount, or an account from which the amount of funds will be transmitted.

11. The apparatus of claim 10, wherein the interface enables the user to split the amount of funds into multiple smaller amounts.

12. The apparatus of claim 11, wherein splitting the amount of funds enables the user to select multiple sources of payment or accounts from which the amount of funds will be transmitted.

13. The apparatus of claim 10, wherein the module generates a dynamic list of payees based on the second apparatus' proximity to the apparatus, wherein the proximity is determined using location information associated with the second apparatus.

14. The apparatus of claim 1, further comprising: determining an account from which the amount of funds will be transmitted, and in response to determining the account from which the amount of funds will be transmitted, processing the payment information to determine whether the account from which the amount of funds will be transmitted comprises sufficient funds to complete the transaction.

15. The apparatus of claim 1, wherein transmitting an acknowledgement of payment transfer comprises generating a receipt or a receipt image of transaction information.

16. The apparatus of claim 1, wherein the acknowledgement comprises at least one of a text message, an email, a notification, a status update, a digital receipt, or a printed receipt.

17. The apparatus of claim 1, wherein the readable indicia is static or dynamic.

18. The apparatus of claim 1, wherein the module processes the payment information via a transfer network.

19. A method for making a mobile payment via a transfer network, the method comprising:
receiving, using a computing processor device, at a first apparatus, readable indicia and payment information from a second apparatus, wherein the readable indicia is configured to be associated with more than one merchant, wherein the payment information comprises an amount of funds, and wherein the amount of funds comprises at least one of a subtotal, a tax, a tip, and a total amount, and is modifiable by an end user;
identifying, using a computing processor device, an account associated with the readable indicia based on searching a database of records;
processing, using a computing processor device, the payment information, wherein processing the payment information comprises transmitting to the identified account the determined amount of funds;
transmitting, using a computing processor device, an acknowledgement of payment transfer to a third apparatus associated with the identified account.

20. A non-transitory computer program product for making a mobile payment via a transfer network, the computer program product comprising a non-transitory computer-readable medium comprising code causing a first apparatus to:
receive readable indicia and payment information from a second apparatus, wherein the readable indicia is configured to be associated with more than one merchant, wherein the payment information comprises an amount of funds, and wherein the amount of funds comprises at least one of a subtotal, a tax, a tip, and a total amount, and is modifiable by an end user;
identify an account associated with the readable indicia based on searching a database of records;
process the payment information, wherein processing the payment information comprises transmitting to the identified account the determined amount of funds;
transmit an acknowledgement of payment transfer to a third apparatus associated with the identified account.
